(19) United States
(12) Patent Application Publication
(10) Pub. No.: US 2012/0058363 A1
(43) Pub. Date: Mar. 8, 2012

(54) COATED LIGHTWEIGHT METAL DISK

(75) Inventors: Clemens Maria Verpoort, Monheim (DE); Maik Broda, Eschweiler (DE)

(73) Assignee: FORD GLOBAL TECHNOLOGIES, LLC, Dearborn, MI (US)

(21) Appl. No.: 13/319,650

(22) PCT Filed: Apr. 19, 2010
(86) PCT No.: PCT/EP10/55114

§ 371 Date: Nov. 9, 2011

(30) Foreign Application Priority Data
May 13, 2009 (DE) 10 2009 021 213.2
May 15, 2009 (DE) 10 2009 003 161.8

(51) Int. Cl. F16D 65/12; F16D 13/64; C23C 4/06; B32B 15/18; B32B 15/01; B32B 15/20; B32B 5/00; C23C 4/02; C23C 4/12

(52) U.S. Cl. 428/649; 427/422; 188/218 XL; 192/107 M; 427/327; 427/419.1; 427/455; 428/686; 428/650; 428/660; 428/681

(57) ABSTRACT

The invention relates to a coated lightweight metal disk, in particular a brake disk, comprising a support disk made of a thermally resistant lightweight metal alloy, and a heat-insulating friction layer formed from a metal alloy that includes nanocrystals. The friction layer can be applied directly to the support disk without adding an insulating intermediate layer. Because of the thermally insulating effect of the friction layer, only a moderate amount of heat is transferred to the support disk.

Friction disks often comprise a support disk with a friction lining or a friction coating and are used as brake disks or clutch disks, in particular on vehicles, rail vehicles, cable cars and the like. Brake disks serve the purpose of converting kinetic energy into frictional heat. On account of the large amount of heat that is quickly generated, it is necessary to take measures to dissipate heat and use materials that are thermally resistant.

It is state of the art in automotive engineering to use friction disks having an iron alloy support disk, such as gray cast iron, with wearing layers applied to them. Among the disadvantages of iron alloy based brake disks is their great weight. In view of the constantly increasing need for weight savings, it is attempted on one hand to replace this heavy support disk material with lighter materials, while on the other hand there is increasing demand for high-performance brakes that have outstanding braking properties, excellent braking smoothness, and at the same time the longest possible service life, which lighter materials may not be able to support. Lightweight metal has the disadvantage that it requires other coatings and has different properties with regard to thermal resistance.

Lightweight wear-resistant disks are also desired in other applications, such as rail vehicles, to meet the demand for lightweight construction and requirements relating to energy savings and service life. In the case of clutch disks, lightweight disks are desirable because of faster possible rotational acceleration and overall weight savings.

The invention is explained below on the basis of automobile brake disks, but is not in any way restricted to such applications.

The customary wearing of brake disks is caused by the loads to which the braking areas are subjected. It is desired that braking areas be abrasion-resistant and remain adhesively bonded to the support disk stably under thermal loads. Further wearing of brake disks may be known as “stroking wear,” which may be caused by geometrical defects and material cohesion defects on the support disk that are conducive to uneven abrasion. Distortion of the disk during braking as a result of dimensional inaccuracies and material problems may likewise lead to uneven wear. Finally, corrosion damage to the brake disks, as occurs if the vehicle is not driven for some time, likewise may have the effect of reducing service life.

Brake disks of this type are known, for example, from DE 10 2004 052 673 A1, DE 103 42 743 A1, or EP 1013956 B2.

In DE 102004016096 it is proposed to use cermet materials on aluminum support disks as brake disks. Ceramic material substantially comprising aluminum and titanium oxide is applied to a support disk. The combination of coating materials is intended to achieve increased thermal conductivity (more than 30 W/° C. m).

A problem when using aluminum disks lies in the low temperature resistance and low hardness of the aluminum material. The braking energy absorbed by the brake disk increases with the weight of the vehicle and with the square of the speed of the vehicle. The braking energy produces a high frictional heat flow from the disk into the wheel hub and into the wheel mounting. Therefore, to not allow the heat that is produced on the outer friction ring to reach the aluminum hub flange of the support disk, complex constructions are known that involve the use of intermediate flanges of solid ceramic as a heat-insulating layer. It is also known, for example from U.S. Pat. No. 5,612,110, to use expensive plasma-sprayed zirconia heat-insulating layers with stabilization by rare earth metals such as yttrium.

The inventors have recognized that neither the heat dissipation through the wheel hub by means of highly heat conductive layers nor the use of separate insulating layers, which may give rise to additional problems of adherence, leads to friction disks with the required service lives that are suitable for mass production.

According to the invention, the friction layer itself may be formed as a heat-insulating metallic layer. Metals are good heat conductors, at least in comparison with cermet materials. In particular, aluminum compounds with more than 200 W/m° C. are among the best heat conductors. Even gray cast iron and iron-aluminum alloys still have a thermal conductivity of several 10 W/m° C. The wear resistant disk according to the invention, in particular a brake disk, may comprise a lightweight metal support disk of thermally more resistant lightweight metal alloy, such as a hypoeutectic aluminum-silicon alloy, and a heat-insulating friction layer of a metal alloy comprising nanocrystals. In this case, the formation of the nanocrystals (the grain size of which is less than 100 nm) leads to the desired, significantly reduced thermal conductivity of well below 10 W/m° C. In addition, the heat-insulating metallic friction layer has a high coefficient of friction, which corresponds at least to the value customary in the case of brake disks of 0.45.

It has been found that nanocrystalline metal layers with a considerably lower thermal conductivity than metal layers of the same composition with a coarser grain can be produced particularly reliably on the relatively thin support disk of brakes or clutches. The explanation for this given by the inventors is that the physical properties of materials may change drastically as soon as they are no longer homogeneous. According to the understanding of the inventors, the interior of the grain normally dictates the behavior of the material. Whenever the crystallite size changes from the millimeter range to the nanometer range (nanocrystals with grain sizes below 100 nm), there is a different ratio between the grain boundary surface and the grain interior. At the transition to the nano range, the proportion of imperfect grain boundary material in the ratio increases, with the “imperfect regions” in the crystal lattice of the grain boundary material increasingly determining the properties of the friction layer. These imperfect regions are regarded as largely amorphous. Imperfect regions of this type have diameters of the order of magnitude of 1-3 nm.

A further advantage of applying the metal insulating layers to the lightweight metal support body is that metal/metal bonding may be achieved. Since metal layers butt against one another, diffusion processes that are conducive to bonding may possibly take place at the boundaries of the two materials and the connection is not loaded as much under thermal stress as a result of similar coefficients of expansion. As a result, fewer connection problems between the support disk and the friction layer occur and complex means of attachment can be avoided, since, on account of the smaller difference of expansion, the connection between the two metals is also subjected to less loading under the increased braking temperature as a result of the heat-insulating metallic friction layer.

Instead of the thermally insulating ceramic layers used in the known brake disks, it is now also possible to use less expensive metallic materials that are compatible with the metal support and are thermally insulating as a result of the nanostructure without losing their other properties such as good adherence to other metal layers, ductility, and the like. In addition, the nanostructure in conjunction with the carbides produced in the layer leads to a coefficient of friction of more than 0.48, which may be advantageous for a high braking effect.

To improve the adherence, adhesion-promoting layers may also be applied, or fluxing agents may be used in the case of thermal spraying, to remove/reduce any oxides on the lightweight metal layer that hinder the adhesive attachment of a new metal layer.

It may be advantageous to produce the nanocrystalline metal layer by thermal spraying. Thermal spraying methods include detonation spraying, flame spraying, high-speed flame spraying, cold-gas spraying, laser spraying, arc spraying, and plasma spraying. Favorable methods for the production of nanostructures are all methods that lead to very strong atomization of the melt droplets, and high gas velocities at the nozzle outlet and possibly also high temperatures of the melt, which then atomize more easily.

Favorable for the thermal spraying method, in particular for spray materials that can be supplied in wire form, is plasma spraying, in particular plasma transferred wire arc (PTWA) spraying. This is used, for example, for the coating of engine blocks with metal antifriction layers. A factor here may be the tribologically optimized properties of the antifriction layer. A factor here is the tribologically optimized properties of the antifriction layer, which may be at most 300 micrometers thick. High-speed flame spraying, which has the advantage of high gas acceleration in the spray mist, may also be used.

The impingement of very small molten metal droplets, which can be produced by PTWA, creates nanostructures yielding the desired properties of the heat-insulating layer with a high coefficient of friction. The method can be adapted without problem to the respective conditions and can prevent oxidation in the heat-insulating layer thus formed, for example, by choice of the transporting gas, or else promote the occurrence of hard nitrides and carbides by adding corresponding gases, such as nitrogen or gases containing carbon.

For weight saving reasons and also on account of the mechanical properties of a lightweight brake disk, a support disk of lightweight metal alloy selected from the group comprising aluminum alloys, magnesium alloys, titanium alloys, all of the aforementioned also as hard-material and/or fiber-reinforced alloys, is used. Particularly fiber-reinforced alloys have the advantage of lower distortion under thermal loading and consequently greater stability.

Hereafter, an alloy is understood as meaning both the metal itself, its alloys and also forms thereof that are reinforced with hard materials or fibers.

At the same time, those selected from the group comprising nanocrystalline iron alloys and nanocrystalline aluminum alloys may be advantageously suitable for the heat-insulating layers.

Of the iron alloys, in some cases particularly nanocrystalline steel alloys are suitable on account of their mechanical resistance and their lower thermal conductivity.

The lightweight metal support disks may be produced inexpensively from lightweight metal extruded profiles. Methods for extruding lightweight metal are known and comprise both the extrusion of lightweight metal powder and the extrusion of solid material, preference being given to highly heat-resistant aluminum materials, which can be determined from the known tables, such as the relevant reference publications for alloys (for example Aluminumschlüssel [aluminum key], Dr. John Datta, Aluminium-Verlag Marketing & Kommunikation, Düsseldorf).

The method for producing a coated support disk according to the invention may have the following steps: presenting a lightweight metal base body or support disk and thermally spraying on a mechanically resistant metal alloy under conditions conducive to the formation of nanoparticles in the sprayed layer. Particularly for spray material that is easily obtainable in wire form, PTWA is suitable as the application method. By this method, a molten drop can be produced for a very short time in the plasma flame when the material is processed in the PTWA torch and then be deposited by the secondary gas. This causes the drop to be atomized and accelerated to several times the speed of sound. The very small droplets are deposited onto the surface of the target material, such as the support disk itself, or a layer located on it such as an adhesion-promoter layer, in the form of splats. Splats may have a diameter of the order of magnitude of 30-60 micrometers and a thickness of only 10-30 micrometers. When they impinge on the underlying surface, heat is at the same time extracted from these small splats, which have a very low thermal capacity, at rates of the order of magnitude of 1×10⁶° C./sec. This causes the melt to solidify in a glassy form, since the cooling rate is too high for crystal formation, and the splats remain amorphous. When the next splats impinge at high temperature, the precipitation of nanocrystallines takes place in the layer of splats as a result of the temperature increase. It has been possible to confirm this by transmission electron microscopic (TEM) examination of the layers thus formed, crystal sizes or grain sizes of somewhat below 100 nanometers, for example 60 nanometers, being obtained for the precipitated crystallites when using PTWA and chromium-steel alloy as the spray wire. At the same time, the coefficient of friction can be increased by relatively large splats (50-60 micrometers).

To improve the adhesive attachment of the sprayed heat-insulating layer, the surface of the lightweight metal base body may be prepared before the thermal spraying by chemical and/or mechanical working. Suitable mechanical methods are roughening by grooving, sand or shot blasting, initial grinding or embossing. However, laser treatments may also be used. Lightweight metal base bodies may also be chemically prepared, by etching, degreasing, and other methods familiar to a person skilled in the art.

If the chemical adhesion between the heat-insulating layer and the support disk appears to be inadequate, it may be favorable to apply an adhesion promoter to the surface of the lightweight metal base body before the heat-insulating layer. A typical adhesion-promoter layer for an aluminum base and steel friction layer is a nickel/aluminum adhered surface.

Adhesive attachment may also be improved mechanically by interlocking between the layers, for example by channels with undercuts, in particular by dovetail geometry.

When reference is made here to support disks, this is only intended to illustrate the application for friction disks such as brake disks or clutch disks by way of example. This coating method may be used for all mechanical components that are subjected to frictional loading and have a lightweight metal base body and a friction layer, such as brake drums, friction drums, cone clutches, synchronizing rings, etc.

Without in any way being restricted to them, the invention is explained in more detail below on the basis of exemplary embodiments and the drawings, in which:

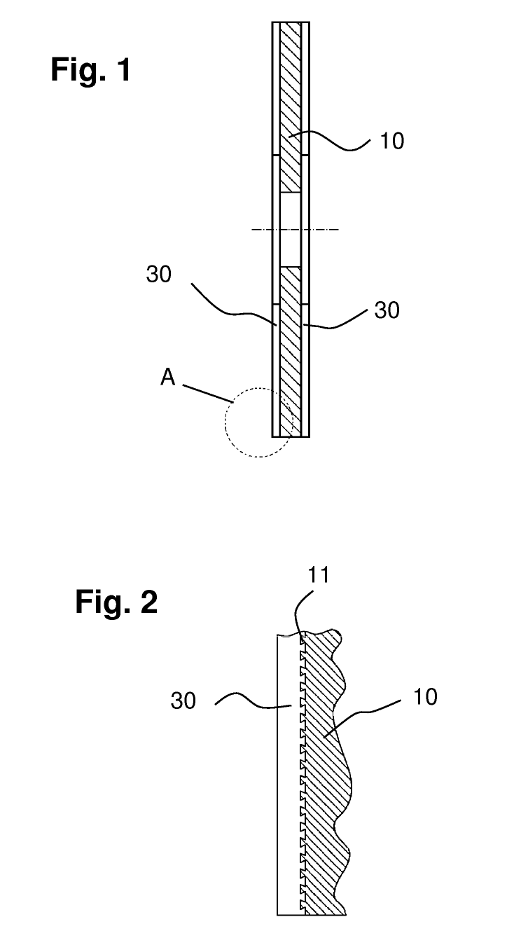

FIG. 1 is a cross section view of a coated support disk;

FIG. 2 is a magnified view of region A of the coated support disk illustrating a dovetail serration between the layers;

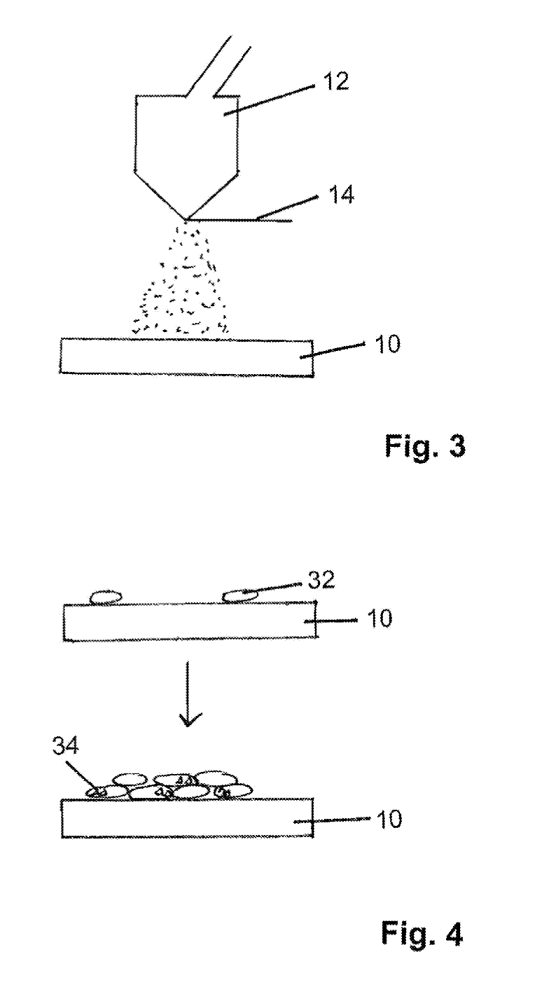

FIG. 3 shows a PTWA installation for spraying a heat-insulating layer onto a support disk; and

FIG. 4 shows a sequence of the structural transformation of glass splats formed by PTWA with subsequent crystallite formation in the same.

In FIG. 1, a brake disk for land vehicles is schematically represented. The brake disk has a support disk 10 with an attachment opening 20 and a friction layer 30 applied to it. The relative sizes are not shown to scale.

In FIG. 2, enlarged detail A from FIG. 1 is represented. Dovetail-shaped channels 11 have been introduced on the support disk 10, with the effect that the sprayed-on friction layer 30 is mechanically locked together with the support disk 10 and, consequently, very good adhesion of the friction layer 30 on the support disk 10 is achieved.

In FIG. 3, an application installation for the PTWA spraying method is schematically shown. A PTWA spray head 12 melts a metal wire 14 by means of plasma, and then uses a transporting gas and possibly a secondary gas to atomize the metal wire 14 material that has melted in the plasma and transport it at high speed onto the support disk 10. As shown in the upper portion of FIG. 4, an amorphous glassy splat 32 initially forms on the support disk 10, and then, as can be seen from the lower portion of FIG. 4, the next impinging splats cause crystallites 34 to be formed. The crystallites 34 may be formed to some extent in the splats 32 as a result of heating. A uniform crystal structure is not formed on account of the rapid cooling of the microstructure, but instead amorphous, disordered regions 36 remain. When new splats impinge on the splats already deposited, sinter-like diffusion processes take place at the splat boundaries, thereby producing the friction layer 30. A sprayed layer produced in this way, with multiple layers of relatively small thickness (10-20 micrometers), may have good hardness, abrasion resistance, corrosion resistance, relatively good thermal insulation, and a good coefficient of friction. The sprayed layer thus produced is consequently particularly suitable for the friction layer 30 to be used on brake disks and other friction-loaded mechanical components with a total thickness of, for example, 500 micrometers.

The coating may proceed from the axis of rotation in the radial direction with the support disk 10 rotating. Its rotational speed is typically several hundred revolutions per minute. The coating rate in the radial direction may increase with the distance from the axis of rotation (approximately corresponding to the circumferential speed), to keep the layer thickness as constant as possible in the radial direction as well. Correspondingly, the coating rate would decrease in the radial direction if the PTWA spray head were guided from a greater radius to a smaller radius. The axis of rotation may be aligned approximately horizontally, with each side of the brake disk being coated by a PTWA spray head. The spray heads may be offset by about 180° in the circumferential direction, that is to say lie diametrically in relation to the axis of rotation. The brake disks produced with the sprayed layers may be ground in the usual way.

Exemplary embodiments of brake disks for land vehicles are given below:

### EXAMPLE 1

Brake Disk for Motor Vehicles with a Mechanically Attached Wearing Layer:

A powder-metallurgically produced support disk 10 of the thermally resistant aluminum alloy AlSi20Fe5Ni2, reinforced with 10% by weight SiC, is provided with dovetail geometry 11.

On this support disk 10 provided with the dovetail geometry 11, a FeCrBSiC sprayed layer is applied by means of PTWA with a steel spray wire. The steel spray wire has the following composition in percentages by weight: iron (Fe); chromium (Cr) 20-40%, preferably 25-35%; boron (B) 3.5-4.4%, preferably 3.7-4%; and small amounts of C and Si. The coating takes place in multiple layers each of a thickness of 10-30 micrometers, up to a total thickness of about 600 micrometers, preferably each of a thickness of 10-20 micrometers, up to a total thickness of about 500 micrometers.

With a weight saving in comparison with conventional vehicle brake disks of about 30%, the brake disk produced in this way showed a similar stability and corrosion resistance.

### EXAMPLE 2

Brake Disk for Motor Vehicles with a Metallurgically/Chemically Attached Wearing Layer:

A support disk 10 produced by die casting from the aluminum alloy AlSi20Fe5Ni2 is sand-blasted. Shortly after the sand-blasting, a Ni—Al alloy, preferably 95/5, or a Ni—Cr alloy, preferably 80/20, is applied to the support disk 10 as an adhesion promoter 24 to prevent oxidation of the exposed surface.

A FeCrBSiC sprayed layer is applied to the adhesion promoter layer by means of PTWA with a steel spray wire having a core of potassium aluminum fluoride as a fluxing agent. The steel spray wire has the following composition in percentages by weight: iron (Fe); chromium (Cr) 20-40%, preferably 25-35%; boron (B) 3.5-4.4%, preferably 3.7-4%; and small amounts of C and Si. The coating takes place in multiple layers each of a thickness of 10-30 micrometers, up to a total thickness of about 600 micrometers, preferably each of a thickness of 10-20 micrometers, up to a total thickness of about 500 micrometers. In comparison with conventional brake disks with a cast-iron support body, the brake disk produced in this way has a weight saving of 30% with the same or better characteristics with regard to stability and corrosion resistance.

The spray wire with a fluxing agent core has the advantage that surface impurities, such as oxides, on the underlying surface are etched or destroyed by the fluxing agent, which improves the adhesive attachment of the sprayed layer. The spray wire filled with fluxing agent can be produced, for example, by applying fluxing agent powder to metal sheets, rolling the sheet into a tube and subsequently drawing the roll to a desired wire diameter. In the chromium-steel layer thus applied it is possible by means of transmission electron microscopy (TEM) to detect nanostructures in the layers thereby produced by way of PTWA. These TEM micrographs showed a mean particle diameter of the splats of 60 μm and partially crystalline structures with crystal sizes or grain sizes of around 50 nm.

### EXAMPLE 3

Brake Disk for Motor Vehicles with a Metallurgically/Chemically Attached Wearing Layer:

A support disk of the extruded thermally resistant aluminum alloy AlSi20Fe5Ni2 is mechanically roughened by a suitable roughening method. After that a Ni—Al alloy, preferably 95/5, or a Ni—Cr alloy, preferably 80/20, is applied to the support disk 10 as an adhesion promoter 24.

By flame spraying, a pulverulent steel alloy is heated with an oxy-fuel flame and, while additional compressed air is supplied, is sprayed at high speed onto the adhesion-promoter layer on the aluminum support disk. The method operates with a flame of an oxy-fuel mixture which entrains and heats up the molten materials. A powder of the following composition is applied as the sprayed layer, the figures being given in percentages by weight: iron (Fe); chromium (Cr) 22-28%; boron (B) 1.5-4.5%; molybdenum (Mo) 3-4.5%, tungsten (W) 1-6.8%; niobium (Nb) 3-4%, silicon (Si) 0.2-1.2%; carbon (C) 0.1-1%; manganese (Mn) 0.5-0.9%; nickel (Ni) 0.2-0.5%. The coating takes place in multiple layers each of a thickness of 10-30 micrometers, up to a total thickness of about 600 micrometers, preferably each of a thickness of 10-20 micrometers, up to a total thickness of about 500 micrometers. In addition, the nanostructure in conjunction with the carbides produced in the layer leads to a coefficient of friction of more than 0.48, which is advantageous for a high braking effect.

With a weight saving in comparison with conventional vehicle brake disks of 30% and more, the brake disk produced in this way showed comparable characteristics with regard to stability and corrosion resistance.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### LIST OF DESIGNATIONS

10 support disk

11 dovetail channels

12 PTWA spray nozzle

14 metal wire

30 friction layer

32 glassy splat

34 crystallites

1. A coated lightweight metal disk comprising:
a support disk made of a metal alloy and a heat-insulating friction layer disposed adjacent to the support disk, wherein the heat-insulating friction layer is a metal alloy comprising nano crystals.

2. The disk of claim 1 wherein the heat-insulating friction layer comprises splats.

3. The disk of claim 2 wherein the splats comprise crystallites.

4. The disk of claim 1 wherein the metal alloy is an aluminum alloy, a magnesium alloy, or a titanium alloy.

5. The disk of claim 1 wherein the heat-insulating friction layer is an iron alloy or an aluminum alloy.

6. The disk of claim 1 wherein the coated lightweight metal disk is a brake disk.

7. The disk of claim 1 wherein the coated lightweight metal disk is a clutch disk.

8. The disk of claim 1 further comprising an adhesion-promoter disposed between and in engagement with the heat-insulating friction layer and the support disk.

9. A method for producing a wear-resistant friction disk, the method comprising the steps of:
providing a friction disk having a surface; and
thermal spraying a metal alloy layer onto the surface of the friction disk such that nanoparticle crystallites are precipitated in the metal alloy layer during thermal spraying.

10. The method of claim 9 further comprising the step of preparing the surface of the friction disk before the step of thermal spraying by chemical and/or mechanical working.

11. The method of claim 9 further comprising the step of applying an adhesion promoter to the surface of the friction disk before the step of thermal spraying.

12. The method of claim 9 wherein thermal spraying is conducted using detonation spraying, flame spraying, high-speed flame spraying, cold-gas spraying, laser spraying, arc spraying, or plasma spraying.

13. The method of claim 9 wherein thermal spraying is performed using wire plasma transferred wire arc spraying (PTWA).

14. (canceled)

15. The method of claim 9 wherein the metal alloy layer is formed by spraying a plurality of splats onto the surface of the friction disk such that at least a portion of the splats cool to form cooled splats that are amorphous and do not form nanoparticle crystallites until an additional splat is sprayed thereon and transfers heat to a cooled splat to cause the precipitation of nanoparticle crystallites.

16. The method of claim 9 wherein during the step of thermal spraying, the friction disk is rotated about an axis of rotation and the metal alloy layer is sprayed onto the surface of the friction disk proceeding from the axis of rotation in a radial direction.

17. The method of claim 9 wherein the friction disk has a plurality of dovetail-shaped channels and wherein thermal spraying the metal alloy fills the dovetail-shaped channels with the metal alloy.

18. The disk of claim 1 wherein the heat-insulating friction layer has a thermal conductivity below 10 W/m° C.

19. The disk of claim 1 wherein the heat-insulating friction layer has a coefficient of friction of at least 0.45.
